(19) United States
(12) Patent Application Publication
(10) Pub. No.: US 2018/0003467 A1
(43) Pub. Date: Jan. 4, 2018

(54) EXPLOSIVE ORDINANCE DISPOSAL SUITS

(71) Applicants: Terrance Hand, Andover (GB); Alan Hudson, Andover (GB); Edmond Simpson, Andover (GB)

(72) Inventors: Terrance Hand, Andover (GB); Alan Hudson, Andover (GB); Edmond Simpson, Andover (GB)

(21) Appl. No.: 15/197,820

(22) Filed: Jun. 30, 2016

(51) Int. Cl. F41H 1/02; A43B 3/02; A41D 3/00; A62B 17/00; A41D 1/06

(52) U.S. Cl. CPC F41H 1/02; A62B 17/006; A41D 1/06; A41D 3/00; A43B 3/02

(57) ABSTRACT

Explosive ordinance disposal suits having improved protection. The jacket and trousers are configured such that the jacket is worn inside of said trousers.

### BACKGROUND OF THE INVENTION

This invention deals with explosive ordinance disposal (EOD) suits having improved blast-wave and blast related projectiles protection. The EOD suits of this invention are a full body assembly that protects the explosive ordinance disposal soldier/technician from threats caused by bombs, mines and other explosive devices such as IEDs (improvised explosive devices), namely, the resulting blast-wave, including blast overpressure, impact and heat and flame ingress and the resulting blast related projectiles, including fragmentation, impact and blunt trauma.

The suits of this invention feature the jacket inside the trousers which eliminates the weak point of other current EOD suits, namely, that the blast-wave and blast related projectiles can travel up from the explosion, most typically located on the ground, under the protective jacket, to the detriment of the EOD soldier/technician. The suits of this invention use established material technology together with new and innovative design to improve protection, comfort, and ergonomics. The materials are well-known to those in the art. For example, Nomex® and Nomex®/Kevlar® are two of such materials. Nomex and Kevlar are trademarks owned by DuPont, Wilmington, Del.

Prior art patents known to the inventors herein include U.S. Pat. No. 7,047,568, issued to Hofmann on May 23, 2006 which deals with a two part protective suit which specifically discloses that the jacket overlaps the trousers.

U.S. Pat. No. 8,347,422 that issued to Kalaam, et al, on Jan. 8, 2013 deals with a protective jacket and U.S. Patent Statutory Invention Registration 7 that published on Jan. 7, 1986 to Martone deals with an explosive ordinance disposal protective suit.

U.S. Pat. D562,501 S, that issued Feb. 19, 2008 to Kalaam, et al and U.S. Pat. D475,812 S that issued on Jun. 10, 2003 to Kalaam et al deal with protective suits.

U.S. Pat. Des 429,384 that issued Aug. 8, 2000 to Crupi, et. al. deals with an ornamental design for a protective body suit.

None of the above described protective suits disclose or show a protective suit having the jacket inside the trousers.

### THE INVENTION

Thus, what is disclosed and claimed herein is a blast protective explosive ordinance disposal suit. The blast protective explosive ordinance disposal suit comprises at least a jacket and trousers, wherein the jacket and trousers are configured to be worn such that the jack is worn inside of the trousers.

Another embodiment of this invention is a combination of the jacket and trousers as set forth just above, a groin protector and over-boots.

Yet another embodiment is a combination set forth just above, hand protective mittens and at least one three-part blast plate.

Still another embodiment of this invention is a blast protective explosive ordinance disposal suit as set forth above, wherein, in addition, there is present an additional groin protector that is fitted beneath the trousers.

### BRIEF DESCRIPTION OF THE DRAWINGS

FIG. 1 is an illustration of trousers of this invention.

FIG. 2 is full front view of an illustration of the suit of this invention showing the jacket and the trousers with Cordura patches on the knees.

FIG. 3 is a back view of the jacket and trousers with collar on the jacket and Cordura patches on the elbows.

FIG. 4 is a full front view of an illustration of an internal additional groin protector of this invention.

FIG. 5 is a full front view of an illustration of a combination of this invention.

FIG. 6 is an integral back protector (not part of the invention).

FIG. 7 is an illustration of a person wearing the invention and the beginning of a blast wave.

FIG. 8 is an illustration of a person wearing the invention and the blast wave beginning to engulf the wearer.

FIG. 9 is an illustration of a full engulfment of the person wearing the invention, by the blast wave.

FIG. 10 is an illustration of a person wearing the invention wherein the blast wave is receding.

### DETAILED DESCRIPTION OF THE DRAWINGS

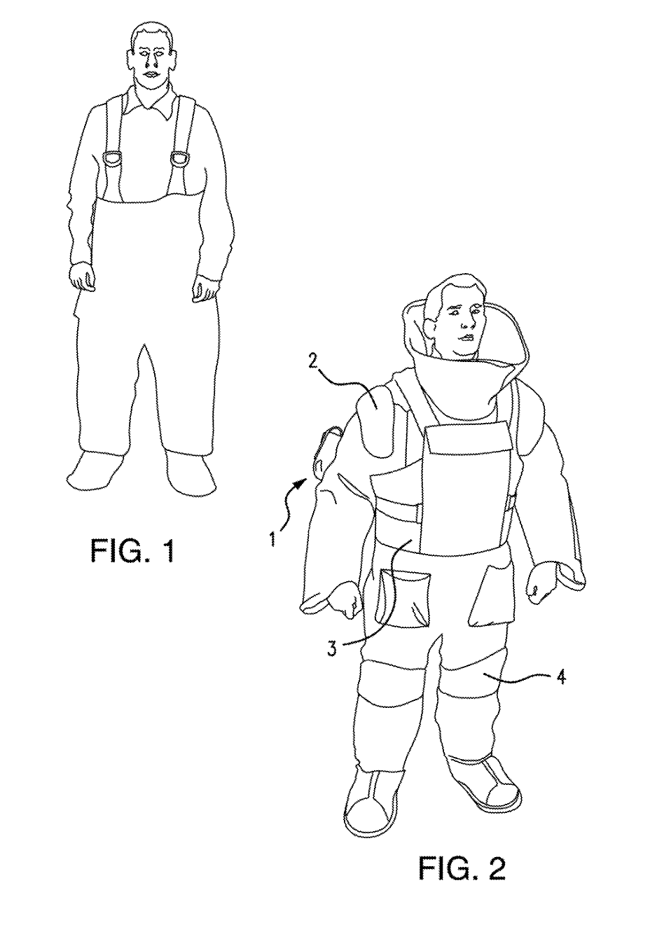

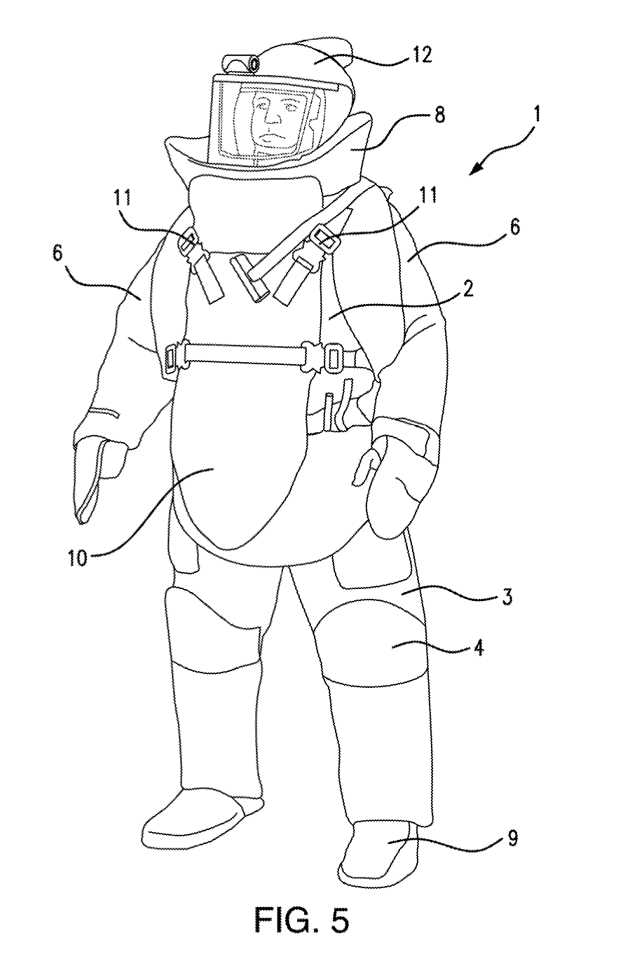

Turning now to FIG. 5, there is shown an illustration of a full complement of a suit 1 of this invention and FIG. 1 is a clear view of the trousers 3 of this invention.

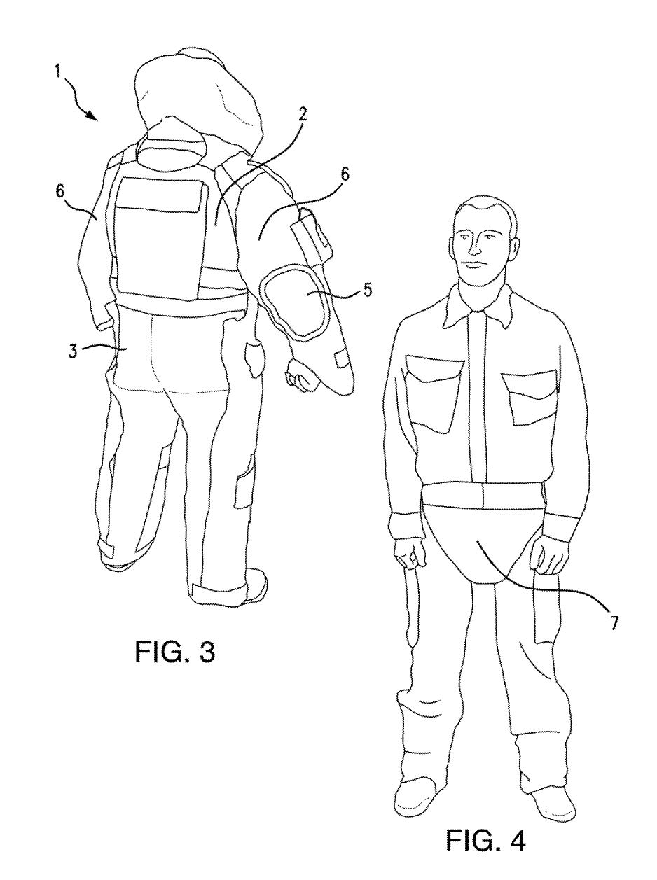

FIGS. 2 and 3 are a much clearer illustration of a combination of a jacket 2 and trousers 3 of this invention in which the jacket 2, which has been designed to fit under the trousers 3, is put on first and then the trousers 3, which have been designed to fit over the jacket 2, are put on next; the trousers 3 are held in place with braces (aka suspenders). This is achieved by configuring the bulk and heft of the fabric of the jacket 2 and the trousers 3 so that the jacket 2 can easily fit under the trousers 3. This is achieved without detracting from the protection capability of the two components and results in enhanced blast-wave and enhanced blast related projectiles protection.

Turning now to FIG. 2, there is shown a full assembly of the jacket 2 and the trousers 3 of this invention showing reinforced Cordura® patches 4 on the knees of the trousers 3, used to extend wear life of the trousers 3.

FIG. 3 is an illustration of the back of the suit 1 showing the jacket 2 and the trousers 3 and Cordura patches 5 on the elbows of the jacket. Also shown in clearer detail are sleeves 6 of the jacket 2.

FIG. 4 is a full front illustration of an internal (internal to the trousers of the suit 1) groin protector 7.

Turning now to FIG. 5, there is shown a full front view of an illustration of a combination of this invention.

Thus, shown is the jacket 2 with sleeves 6, collar 8; trousers 3, with Cordura patches 4 on the knees of the trousers 3, over-boots 9; three part blast plates 10, harness 11 for the blast plates 10; and helmet 12.

The outer fabric of the suit is constructed, for example from Nomex certified flame retardant material. Cordura patches can be fitted to the knees, and the blast plate pouch, and the elbows to extend wear life of the suit.

Similar to prior art, fragmentation protection is achieved through the construction of multiple plies of water repellant treated aramid fibers contained within a nylon armor pack. Similar to prior art, blast overpressure reduction is achieved through a composite type of construction. However, enhanced blast-wave and blast related projectiles protection is achieved by a reconfiguration of the fabric and materials of the jacket and the trousers so as to permit the trousers 3 to be worn outside of the entire jacket 2; wearing the trousers over the jacket channels the blast wave up and away from the body whereas in the conventional design of prior art where the jacket is worn over the trousers, the blast wave travels up the legs and under the jacket impacting the body.

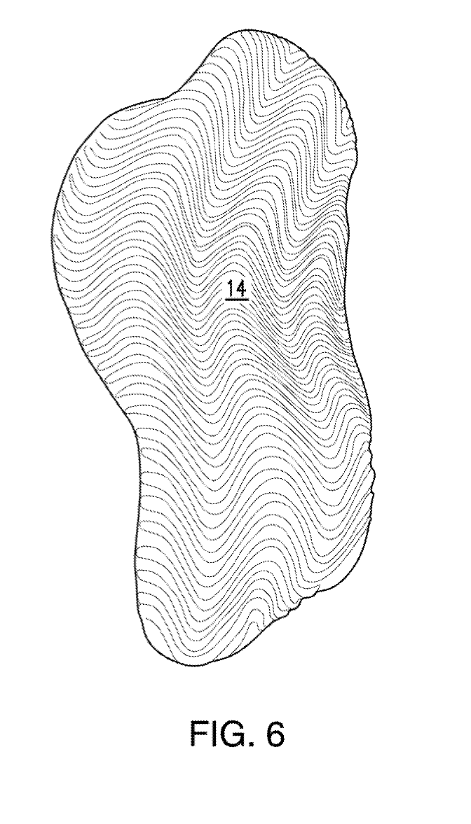

Optionally, there can be used in the combination, an integral back protector 14 as is shown in FIG. 6. This component is CE certified at EN1621-2 level 2, having a thickness of approximate 18 mm, is breathable through air wave technology, waterproof, non-toxic and weighs in the neighborhood of about 400 to 500 grams.

Helmets useful in this invention include closed face helmet and open faced helmet. These helmets are constructed from 100 percent para aramid fibers providing excellent weight to performance characteristics. The helmets are typically coated with epoxy paints in any desired color.

These helmets comprise, generally, a comfort liner with two point harness with adjustable chin cup, removable visor, low noise helmet mounted fan assembly with speed adjuster and battery charge indicator and a helmet mounted light source. It also contains provisions for communications microphone and hearing ear pieces, all of which are known to those skilled in the art.

As an option, the suits can be provided with cooling systems for use in hot environments. The system is worn under the suit and consists of a Nomex body suit with a capillary tube network stitched into it. This is connected to a water reservoir and pump that circulates ice water around the body. The cooling rate is adjustable so that a comfortable working temperature can be maintained.

The greatest threats to the EOD soldier/technician arise from the blast-wave overpressure and blast related projectile fragments emitted from the bomb/IED and other objects in the surrounding area which can impact and enter the body at supersonic speeds. The lightweight, removable, composite ballistic panels fitted to the suit protect the upper torso, shoulder, neck, arms and legs while maintaining lightness and maneuverability. In addition, the suit is supplied with rigid ballistic panels to provide added protection to the chest, lower abdomen and groin areas. The additional benefit of this invention is that the ability to wear the jacket 2 inside of the trousers 3 eliminates a primary means of access of blast-wave overpressure and blast related projectiles from impacting the EOD soldier/technician.

The pressure wave from a blast can cause severe damage to the lungs, eardrums and cause trauma in other body areas. The construction of the suit is such that both sets of ballistic panels limit the effects of the overpressure on the body while the collar completely encloses the neck area and overlaps the helmet. The design of the suit permitting the trousers 3 to be worn outside of the jacket 2 protects the body from the impact of overpressure travelling up from the blast.

The impact of the blast on the body can cause differential acceleration between the head and torso which can break the neck and cause damage to the spine. The suit can be fitted with an articulated spine protector while the raised suit collar overlapping the helmet limits the differential acceleration between body and head.

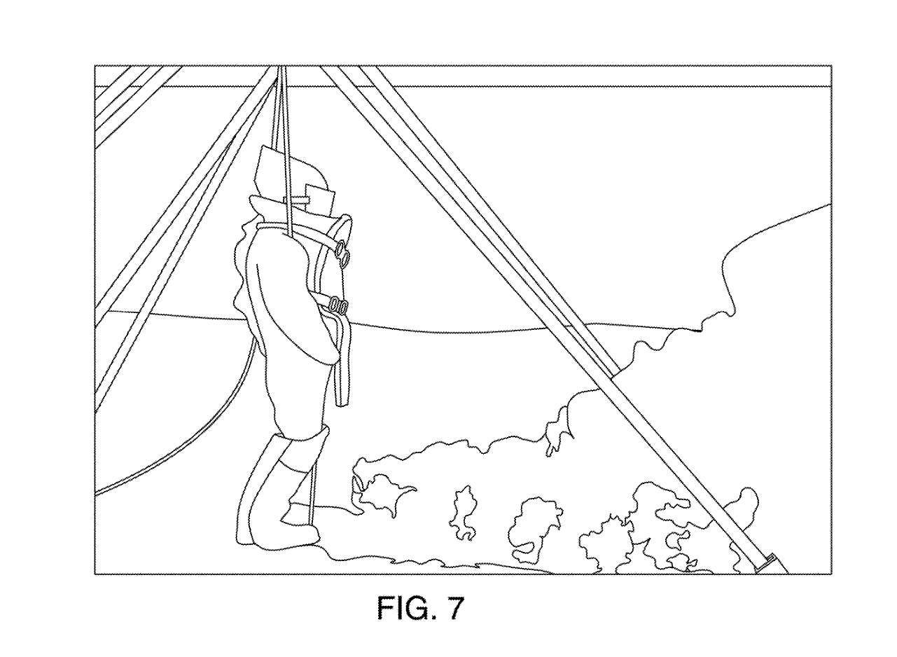

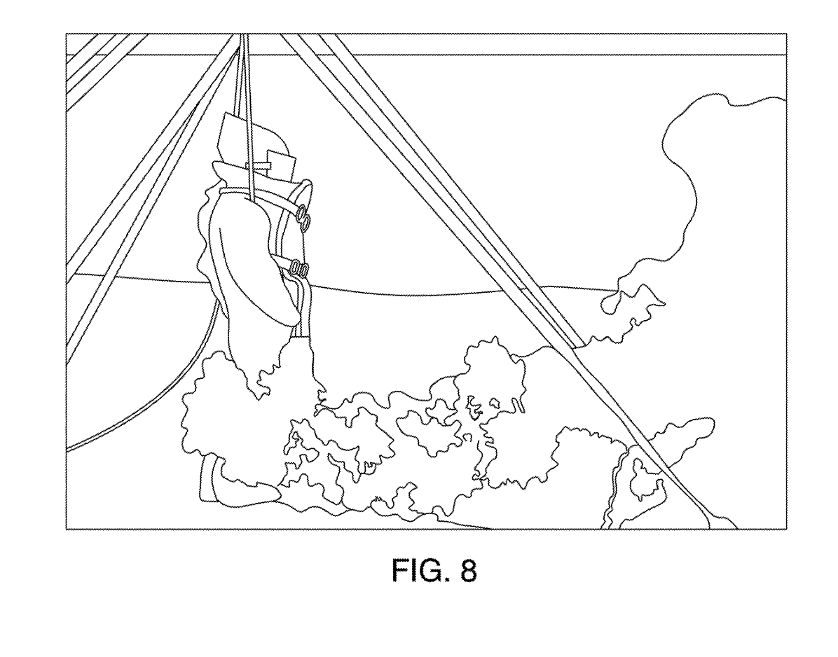

FIG. 7 is an illustration of a person wearing the invention and the beginning of a blast wave 15.

FIG. 8 is an illustration of a person wearing the invention and the blast wave 15 beginning to engulf the wearer.

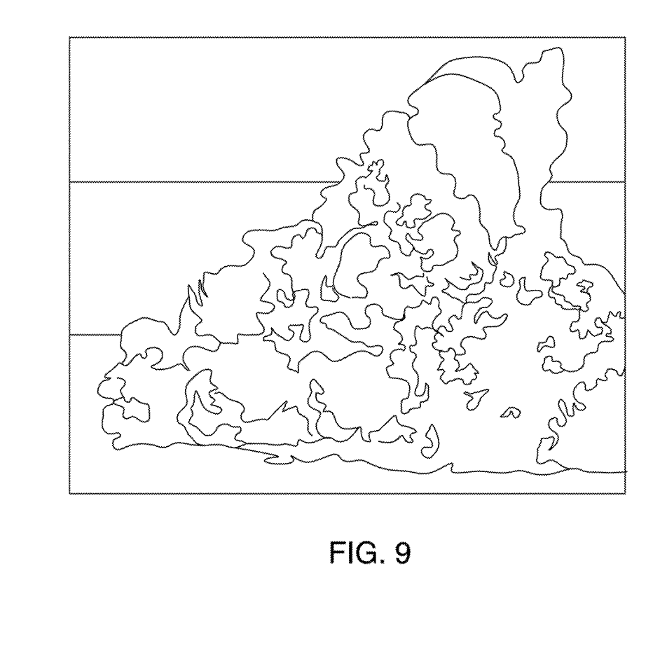

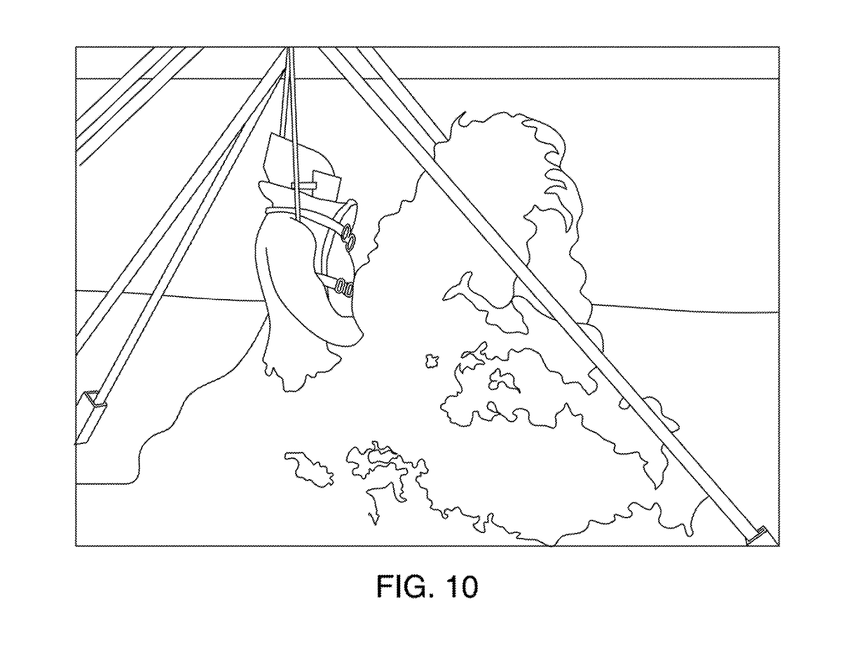

FIG. 9 is an illustration of a full engulfment of the person wearing the invention, by the blast wave.

FIG. 10 is an illustration of a person wearing the invention wherein the blast wave is receding and the EOD suit is intact.

The suits of this invention can be sized from small to extra-large, that is, from a height of 156 cm to at least 195 cm which is a height of from about 5 feet to more than 6 feet.

Thus, the suits of this invention have the key features of zoned armor systems providing exceptional fragment protection, three part, articulated blast plates, with high performance helmet and visor and significant blast over pressure reduction.

What is claimed is:

1. A blast protective explosive ordinance disposal suit, said blast protective explosive ordinance disposal suit comprising at least:
a. a jacket and,
b. trousers, wherein said jacket is configured to be worn inside of said trousers.

2. A blast protective explosive ordinance disposal suit as claimed in claim 1 in which said jacket is configured to fit inside of said trousers.

3. In combination,
a. said jacket and trousers as claimed in claim 1;
b. a groin protector and,
c. Over-boots.

4. In combination,
a. the combination as claimed in claim 3;
b. hand protective mittens and,
c. at least one three-part blast plate.

5. A blast protective explosive ordinance disposal suit as claimed in claim 1 wherein, in addition, there is present an additional groin protector that is fitted beneath said trousers.

6. A blast protective explosive ordinance disposal suit, said blast protective explosive ordinance disposal suit comprising at least:
a. Trousers, said trousers having over-boots for the feet, said trousers being capable of being worn over the jacket;
b. a jacket, said jacket having sleeves, a collar and hand protective mittens, said jacket being capable of being worn inside said trousers;
c. A helmet, said helmet comprising a comfort liner, visor, light and adjustable demister, battery pack, integrated communications microphone and ear pieces;
d. Three part blast plates, and,
e. An internal groin protector.
